(19) United States
(12) Patent Application Publication
(10) Pub. No.: US 2010/0148393 A1
(43) Pub. Date: Jun. 17, 2010

(54) Casting Kit and Method of Using Same

(76) Inventor: Roger Casas Carrillo, Hermosa Beach, CA (US)

Correspondence Address: COLIN RASMUSSEN, 3027 MICHELLE DRIVE, COLTON, CA, 92324, US

(21) Appl. No.: 12/639,488

(22) Filed: Dec. 16, 2009

Related U.S. Application Data
(60) Provisional application No. 61/122,869, filed on Dec. 16, 2008.

(51) Int. Cl. B29C 39/02

(52) U.S. Cl. 264/227

(57) ABSTRACT

The present invention comprises a casting kit and methods of use of the kit for producing castings of objects. In some embodiments a kit comprises a foam impression material, instructions for use, and materials for shipping an impression to a casting service provider. In some embodiments, a method of use comprises a customer making an impression(s) of an object(s) (e.g., a body part such as hands, feet, and paws), and then sending the impression(s) to a casting shop. The impression(s) are used to produce a positive blank of the object. In some embodiments, positive blanks are used to produce a mold in casting sand. Glass or other suitable casting material are poured into the sand mold and allowed to harden. The casting is then further finished and returned to the customer as a finished replica.

### RELATED APPLICATIONS

The present application claims the benefit under 35 U.S.C. §119(e) of U.S. Provisional Application No. 61/122,869, filed Dec. 16, 2008, and entitled “Crystal Glass Casting Kit and Method of Using Same,” the entirety of which is hereby incorporated by reference.

### FIELD OF THE INVENTION

The invention is in the field of methods of casting, and in particular kits and methods of their use for making glass castings of impressions of body parts and the like for use as memorabilia.

### BACKGROUND

Casting is a well-known manufacturing process whereby a material in liquid form is poured into a mold, the mold representing the topology and volume of an object to be replicated. Molds are generally fashioned from materials that retain their form in the presence of the casting material, for example metal, or packed sand. The casting material can comprise, for example, plaster, plastics, concrete, resins, metals, or glass, and combinations thereof.

Casting is especially useful as a method of replicating complex three-dimensional shapes, which would otherwise have to be produced by uneconomical means, such as hand carving. Furthermore, casting is also a useful and economic way to produce items that are not easily produce by usual methods of machining. Many items have such complex surface topologies such that casting is the only practical method with which to reproduce such shapes.

### SUMMARY OF THE INVENTION

In the past it has been possible to obtain a glass casting of a body part or other desired object. However, such prior art methods typically require the person desiring the casting to go to the place of business of the caster in order to personally provide an impression of the body part of which the replica is desired. In some prior art methods, the person is required to provide an impression in a matrix such as casting sand. This impression is then used as a mold into which molten glass is poured. Once the glass hardens, a glass replica of the impression results, which can be further finished, for example, by sanding, sandblasting, or mounting for display.

A significant limitation in the usefulness of prior art methods lies in the fact that they require the person or object of whom the replica is desired to be brought to the caster in order to make the impression directly in the molding media. In cases where the casting is desired of body parts if small children, infants, or pets, or where the item to be replicated is not suitable for shipping, the process is especially inconvenient and potentially impossible.

Thus, there is a need to a casting kit and method that permits a user to obtain a casting of a body part or other object, without the need to go to the caster's shop to make the required impression necessary for the molding and casting process. There is a further need to provide a casting kit and method that does not require the use of casting sand in order to make a initial replica of an object.

The present invention relates to a crystal glass casting kit and a method of using the same. In some embodiments a kit comprises materials adapted to permit the taking of impression of objects by an endpoint consumer. These impressions are then capable of being used by a person skilled in the art of casting to make replicas of the object used to form the impression. The caster then takes the replicas and uses them to form a mold to produce a finished casting.

Thus, there is provided a method for conveniently producing a casting of at least a portion of an object, the method comprising: providing a kit configured to allow a user to make at least one impression of an object and to send the at least one impression of the object to a casting service provider, the kit comprising: instructions that instruct a user on how to use the kit; an impressionable material onto which an object can be placed; wherein the impressionable material is configured such that pressing of the object onto the impressionable material results in the formation of a depression in the impressionable material; wherein when the object is removed from the impressionable material, the depression formed in the impressionable material is substantially retained; and shipping materials useful for shipping the impressionable material to a casting service provider; forming at least one impression in the impressionable material; placing a molding material into the at least one impression to substantially fill the at least one impression with the molding material, such that at least one positive cast is formed; wherein the at least one positive cast is then used to form a shape to be molded in a casting apparatus; wherein the casting apparatus is then used to form at least one final casting, the at least one final casting having a shape that substantially conforms to the shape of at least a portion of the object.

In some embodiments, the method further comprises sending the impressionable material comprising the at least one impression to a casting service provider.

In some embodiments, the molding material comprises a stone molding material.

In some embodiments, the at least one final casting comprises at least one of glass, resin, plastic, metal, composite material, plaster, and combinations thereof. In some embodiments, the final casting comprises crystal glass.

In some embodiments, the method further comprises the step of annealing the crystal glass.

In some embodiments, the at least one final casting is configured for display. In some embodiments, the at least one final casting further comprises a means of illumination.

### BRIEF DESCRIPTION OF THE DRAWINGS

FIG. 1A illustrates an embodiment of a method of making an impression according to the disclosure.

FIG. 1B illustrates an example of impressions make in a foam material by an embodiment of a method of the invention.

FIG. 2 illustrates an example of impressions in a foam material with some of the depressions having been filled with a material to produce a positive cast.

FIG. 3 illustrates an embodiment of positive casts for use in producing a glass casting mold.

FIG. 4A illustrates an embodiment of a finished casting produced by an embodiment of the invention.

FIG. 4B illustrates an embodiment of a finished casting produced by an embodiment of the invention.

### DETAILED DESCRIPTION OF THE INVENTION

As shown in the accompanying drawings, and as described herein, the present disclosure relates to the invention of a kit and methods for conveniently obtaining a three-dimensional replica of virtually any object. In some embodiments the casting may be made of a body part, for example hands or feet, or a pet's paws.

The kits and methods of the invention are also compatible with obtaining castings of other objects, and so the disclosure should not be seen as being limited only to making impressions of body parts for use as memorabilia. For example the kits and methods described are useful in producing replicas of objects where casting services are not immediately available, or where it is impractical to ship the object of which a replica is desired.

Similarly, while the disclosure describes embodiments for obtaining a crystal glass replica of an object, the methods described herein are adaptable to forming replicas using any suitable casting material, including, and without being limiting, plastics, glass, metal, plaster, gels, resins, concrete, and other materials typically used in the art of casting.

The present invention provides a particular advantage to a consumer who wishes to obtain a replica casting of some object, but for whatever reason it is not convenient for the consumer to attend at a casting shop. In some embodiments, the invention comprises a kit comprising an impressionable material, instructions on how to make impressions, an information card, and a mailing label for permitting easy return to a casting shop.

The kit can be purchased from a retail outlet, or alternatively, may be ordered directly either through an internet-based ordering service, or by traditional mail order. In some cases, the user may take the kit home to be used, or alternatively, a retail outlet may provide on-site assistance in making impressions. Upon opening the kit, the user is directed to refer to the included instructions in order to practice the method of the invention.

In some embodiments, an especially resourceful user could perform all the steps of the method themselves. In some embodiments, the user will engage the services of a casting service provider to perform the more technical steps necessary to produce the final casting.

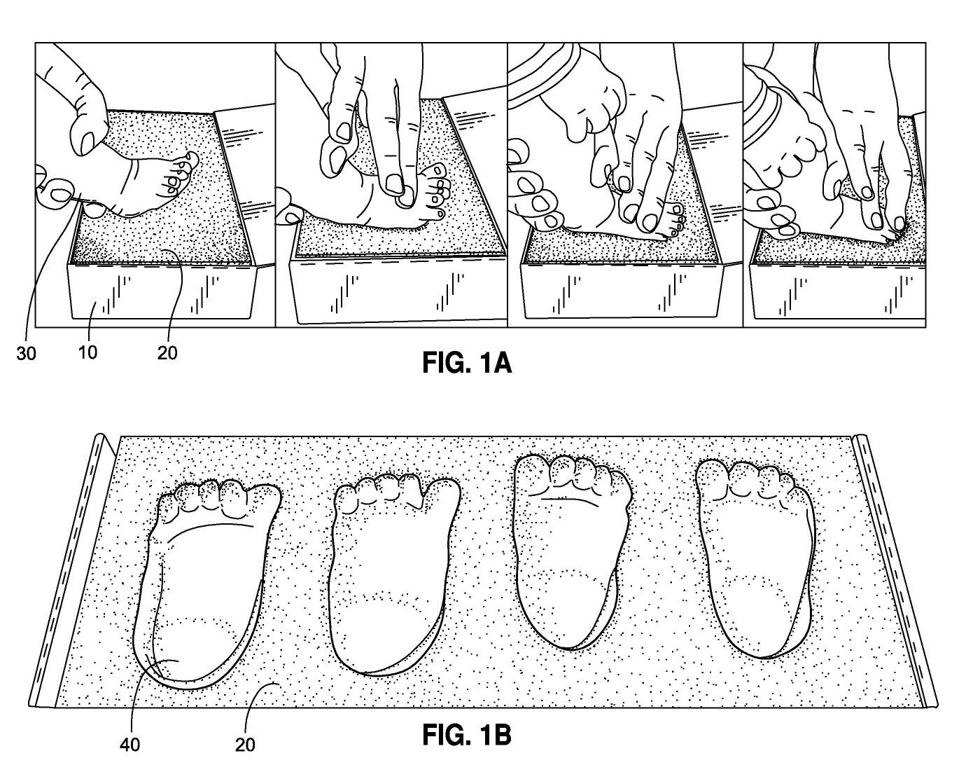

An impressionable material is adapted for use in making impressions of an object for which a 3-dimensional replica is desired. In some embodiments an impressionable foam material is used as the impression material. In some embodiments a clay material can be used as the impressionable material. In some embodiments a modeling clay product can be used. In some embodiments the material can comprise a medical grade product such as Bio-Foam®. As shown in FIG. 1A, the impressionable material 20, can be conveniently provided in a casting box 10, comprising a block of impressionable material.

While the examples described herein use Bio-Foam®, any impressionable material that is capable of retaining the shape of the object used to create an impression in it are suitable for use in the method of the invention, and all such impressionable materials are considered to be within the scope of the invention as described herein.

In some embodiments, an object 30 for which a replica is desired (the example shown in FIG. 1A is an infant's foot) is pressed into the impressionable material 20 (FIG. 1A sequence from left to right). The result of pressing the object 30 into the impressionable material 20 will be three-dimensional depression 40, which represents a negative of a portion of the object 30.

In some cases the user may make a single impression of an object, while in other cases it may be desirable to make multiple impressions of the same object, or impressions of a number of objects in the same block of impressionable material, for example as shown in FIG. 1B.

The making of impressions is relatively simple, involving pressing the object to be replicated into the impressionable material. It will be readily apparent that the depth of the impression will depend on the amount of force applied to the object, and thus performing multiple impressions of the same object provides an advantage of giving a range of impressions, from which the user may select the most desirable.

After making the desired impressions, in some embodiments of the method the user then fills out the information card provided in the kit and seals the casting box 10 for shipping to a casting shop, or to a central clearing house that then directs the box to a casting shop on behalf of the user. Once the casting box arrives at a casting shop, the package comprising the casting box is opened, the user's information is entered into a record keeping system, for example an electronically stored computer database, and an e-mail or other communication is sent to the user confirming receipt of the impressions.

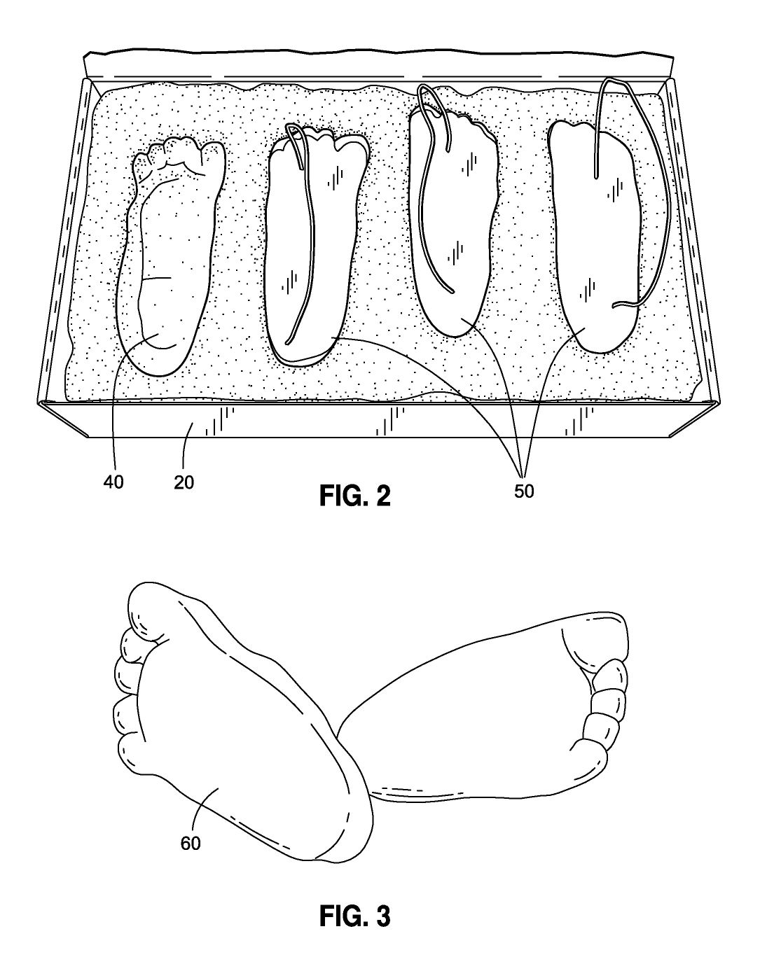

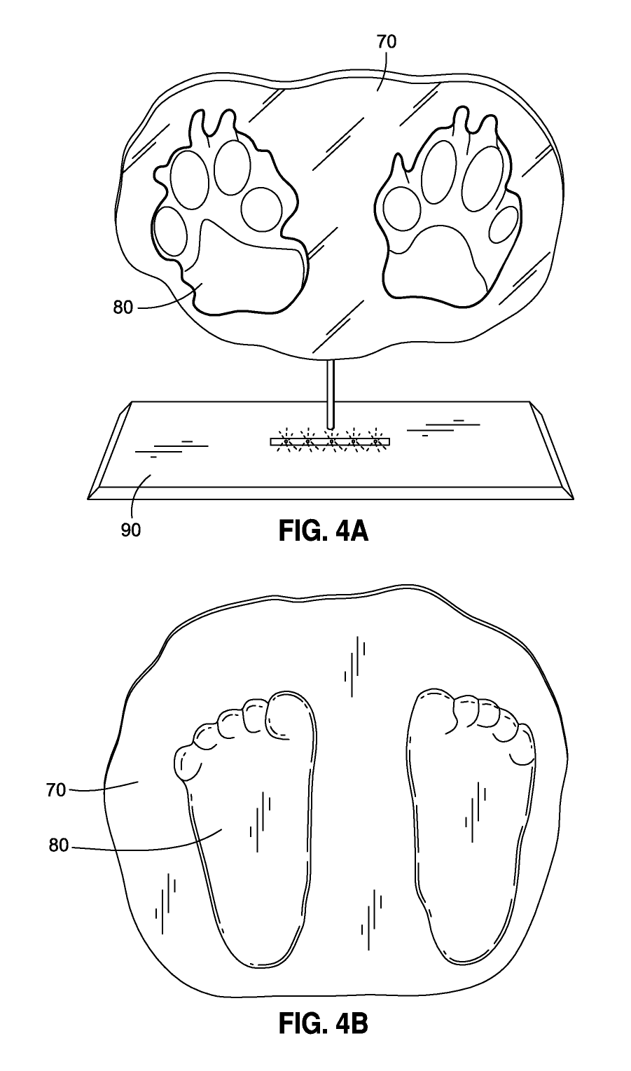

As shown in FIG. 2, the next step is for the caster to fill the impressions 40 with a molding material 50 to make a positive mold of the impressions 40. The molding material 50 may be any material suitable for making a positive mold, for example, material used for making stone molds used in sand casting techniques. In some embodiments ortho-dental stone can be used to produce the positive mold. In some embodiments, resins, plastics, plasters, and other like materials may be used to produce a positive mold. Conveniently, each positive mold can be labeled with a tag corresponding to the consumer (e.g., consumer ID, or order number) so that the molds are properly matched to the correct order.

Once the molding material has hardened, the positive molds can be removed from the impressions in which they were formed. The result, as shown in FIG. 3, is a positive mold 60 that can now be used in subsequent steps in the casting process. The positive mold 60 is a substantially accurate three-dimensional representation of the object used to make the impression.

The positive mold 60 is cleaned of impressionable material prior to use in forming mold with which to make the final casting. In some embodiments, the positive mold 60 is used to make a mold in a sand casting process. In some embodiments, a positive mold 60 may be formed using in a computer-controlled stereolithography process. Sanding and/or grinding tools can if needed be used to clean the positive mold and to remove any imperfections, or to smooth the mold or fix irregularities, prior to the final casting step.

In some embodiments, the positive mold 60 can pressed into damp pure white silica casting sand. In some embodiments, this casting sand comprises sand of 90-110 mesh. A molasses water mixture can be sprayed onto the casting sand to better maintain the shape of the impression. In addition, the use of a molasses solution provides the advantage of aiding in the release of the casting from the mold, as well as to prevent molding sand from sticking to, or fusing with, the casting. Other materials compatible for release of casting can be used in preparing the mold, such treatment being well know to those skilled in the art of casting.

Molding material can then be poured into the impressions formed by the positive mold in the casting sand. In some embodiments the molding material is molten crystal glass. The molding material (e.g., glass) can be ladled or poured into the casting sand mold. Where glass is used as the material, after pouring, the edges of the molten casting are heated with a torch to provide a smoother finish. The use of torch heating is also beneficial to allow the new casting to evenly cool to a temperature of about 980° F. The casting is then allowed to a temperature to allow handling.

In some embodiments, additional agents such as colorants can be added to the mold or to the glass to affect the aesthetic appearance of the final casting.

In the case of a glass casting, once the casting has cooled, it is placed into an annealing kiln for about 7 hours. Annealing is a technique well known in the art that is useful to improve the toughness of glass products. Once annealing is completed, the casting is removed from the annealing kiln and the casting can be buffed or polished.

If desired, each individual casting can be identified with customer information such as an order number, and then packaged for return to the customer. In some embodiments, the casting is further processed to provide locations for attachment of mounting hardware, for example, by drilling holes in pre-selected locations in the casting to accept screws, bolts, pins, or other like mounting hardware. In some embodiments, the display can further comprise lighting, for example LED lights, configured to illuminate the casting. In some embodiments, the glass casting may have engraving on it, for example, names, dates, and the like.

In some embodiments, the casting is returned to the customer without being mounted on a display. In some embodiments, the casting can be mounted on a display suitably sized for the particular casting. One complete, the casting is then packaged and returned to the customer, and the customer now has a three-dimensional replica of the original object.

In using the kit herein described, and by following the instructions comprising the method of the invention, as customer is provided with a manufactured casting of an object desired for memorabilia purposes.

The skilled artisan will recognize the interchangeability of various features from various embodiments. Similarly, the various features and steps discussed above, as well as other known equivalents for each such feature or step, can be mixed and matched by one of ordinary skill in this art to perform compositions or methods in accordance with principles described herein.

Thus, although the disclosure has been provided in the context of certain embodiments and examples, it will be understood by those skilled in the art that the disclosure extends beyond the specifically described embodiments to other alternative embodiments and or uses and obvious modifications and equivalents thereof.

Accordingly, the foregoing is considered as illustrative only of the principles of the invention. Thus, while certain aspects and embodiments of the disclosure have been described, these have been presented by way of example only and are not intended to limit the scope of the disclosure. Indeed, the novel methods and systems described herein may be embodied in a variety of other forms without departing from the spirit thereof.

What is claimed is:

1. A method for conveniently producing a casting of at least a portion of an object, the method comprising:
providing a kit configured to allow a user to make at least one impression of an object, and to send the at least one impression of the object to a casting service provider, the kit comprising:
instructions that instruct a user on how to use the kit;
an impressionable material onto which an object can be placed;
wherein the impressionable material is configured such that pressing of the object onto the impressionable material results in the formation of a depression in the impressionable material;
wherein when the object is removed from the impressionable material, the depression formed in the impressionable material is substantially retained; and
shipping materials useful for shipping the impressionable material to a casting service provider;
forming at least one impression in the impressionable material;
placing a molding material into the at least one impression to substantially fill the at least one impression with the molding material, such that at least one positive cast is formed;
wherein the at least one positive cast is then used to form a shape to be molded in a casting apparatus;
wherein the casting apparatus is then used to form at least one final casting, the at least one final casting having a shape that substantially conforms to the shape of at least a portion of the object.

2. The method of claim 1, further comprising sending the impressionable material comprising the at least one impression to a casting service provider.

3. The method of claim 1, wherein the molding material comprises a stone molding material.

4. The method of claim 1 wherein the at least one final casting comprises at least one of glass, resin, plastic, metal, composite material, plaster, and combinations thereof.

5. The method of claim 4, wherein the final casting comprises crystal glass.

6. The method of claim 5, further comprising the step of annealing the crystal glass.

7. The method of claim 1, wherein the at least one final casting is configured for display.

8. The method of claim 1, wherein the at least one final casting further comprises a means of illumination.
